(19) United States
(12) Patent Application Publication
(10) Pub. No.: US 2006/0055626 A1
(43) Pub. Date: Mar. 16, 2006

(54) Dual screen display using one digital data output

(76) Inventor: Stephane Tremblay, St-Joseph-du-Lac (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/942,099

(22) Filed: Sep. 16, 2004

(51) Int. Cl. G09G 5/00

(52) U.S. Cl. 345/2.2

(57) ABSTRACT

A circuit and method for dual screen display using a single digital video output. Circuitry is provided to sample a single pixel stream input serially but representing two images, separate the pixel stream into the two images, format each pixel stream to correspond to the output device on which the image is to be displayed, and transmit the two pixel streams to each output device.

### CROSS-REFERENCE TO RELATED APPLICATIONS

This is the first application filed for the present invention.

### TECHNICAL FIELD

The present application relates to the field of dual screen displays, and more specifically, to displaying on two displays with only one digital video output.

### BACKGROUND OF THE INVENTION

Driving multiple display devices is quickly becoming the standard for computers, televisions, and many other applications such as active public information displays. Moreover, driving multiple displays has always been an attractive feature for certain types of environments, such as for digital restaurant and bar menus, airport arrival/departure boards, lottery machines, video voting terminals, as well as many other information displays used by various retailers and corporate markets.

Two major obstacles to driving multiple displays using digital video output data are cost and bandwidth. Most systems used to accomplish multi-displays use many graphics controllers. For example, a four-display graphics card would have either two controllers (with each graphics controller having two CRTCs) or four graphics controllers to accomplish the desired four outputs. Graphics controllers are the most costly components of a graphics card. Therefore, multiplication of the number of graphics controllers on a card makes the overall cost of the card increase tremendously.

With respect to bandwidth, having multiple graphic controllers causes bandwidth issues with respect to doing data transfer in between the graphics controllers. FIG. 1 illustrates a common prior art system used for dual display. If a user were to drag a window from one display to another, the graphic operation would translate into a BLIT from the local frame buffer of one graphics controller (for display #1) to the local frame buffer of the other graphics controller (for display #2) across the host interface (commonly PCI). This is a long process that is costly in bandwidth requirements.

Therefore, there is a need for a solution that will reduce both costs and bandwidth required for multi-display of output devices.

### SUMMARY OF THE INVENTION

It is an object of the present invention to multiply a single Digital Video Output (DVO) by two to obtain two DVO outputs from a single one.

In accordance with a first broad aspect of the present invention, there is provided a method for transforming a single digital video output into two digital video outputs, the method comprising: storing digital video output data for a first display and a second display in a local frame buffer, the data comprising a plurality of pixels corresponding to a given resolution; retrieving the data from the local frame buffer and transmitting the data serially to a sampling circuit, the sampling circuit placing pixels for the first display and the second display into separate storage devices; formatting the data for the first display and the second display in accordance with parameters for each display respectively; and transmitting formatted data to a first digital video output line and a second digital video output line.

In accordance with a second broad aspect of the present invention, there is provided a system for transforming a single digital video output into two digital video outputs, the system comprising: a local frame buffer for storing digital video output data for a first display and a second display, the data comprising a plurality of pixels corresponding to a given resolution; a graphics controller to retrieve the data from the local frame buffer and output the data serially; and a sampling circuit adapted to receive the data serially, wherein the sampling circuit places pixels for the first display and the second display into separate storage devices and formats the data for s the aid first display and the second display in accordance with parameters for each display respectively, and outputs the pixels for the first display on a first digital video output line and the pixels for the second display on a second digital video output line.

### BRIEF DESCRIPTION OF THE DRAWINGS

Further features and advantages of the present invention will become apparent from the following detailed description, taken in combination with the appended drawings, in which:

FIG. 1 is the architecture of the prior art for dual display with graphics controllers having only one digital video output;

FIG. 2 is the architecture of an embodiment of the present invention for dual screen with one digital video output;

FIG. 3 is a circuit block diagram of the sampling circuit of the present invention in accordance with a preferred embodiment; and

FIG. 4 is a flow chart of the method of the present invention in accordance with a preferred embodiment.

It will be noted that throughout the appended drawings, like features are identified by like reference numerals.

### DETAILED DESCRIPTION OF THE PREFERRED EMBODIMENT

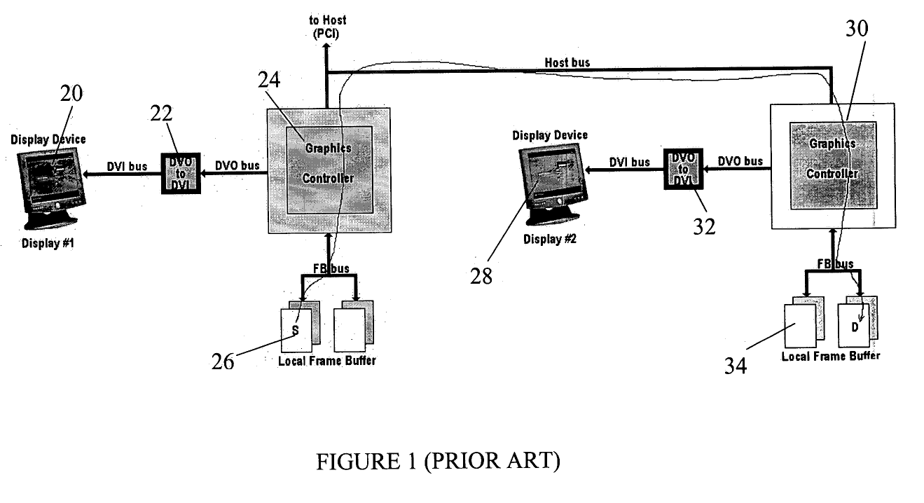

As stated above, FIG. 1 is the prior art for a graphics controller having a single Digital Video Output (DVO). Certain graphics controllers can have two DVO outputs and the present invention can be applied to convert the two DVO outputs into four DVO outputs.

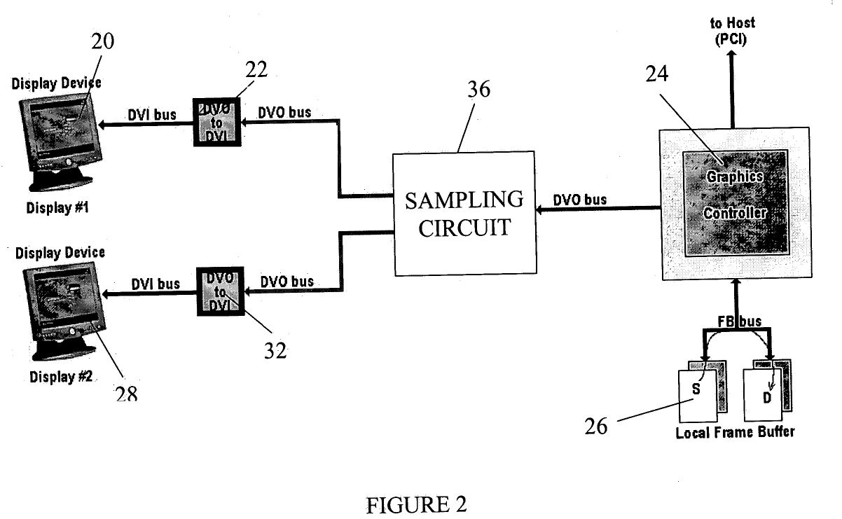

FIG. 2 is a schematic illustration of the layout using the present invention in the case of a graphics controller having only one DVO output. This is a preferred embodiment of the present invention. In FIG. 1, a BLIT operation consists in copying data from the source (S) to the destination (D) in two separate local frame buffers (26, 34) and passing through two graphics controllers (24, 30). The bandwidth required is huge as the data travels along the Host bus to get to the destination. The cost is also doubled due to the second graphics controller 30. In the present invention, the bandwidth is greatly reduced since the source and destination are much closer, as illustrated in FIG. 2. The copying operation happens in a single local frame buffer 26.

The local frame buffer 26 will store the data that is to be displayed on the two output devices (20, 28). There are three possibilities for the output devices: the data can be identical on the two output devices, the data can be stretched across the two devices, and the data can be different on each device and independent from each other.

For the case of identical data, also known as cloned displays, the local frame buffer 26 is only required to store the set of data for the first display 20. The data can be duplicated once retrieved from the local frame buffer 26, or a copy can be made in the local frame buffer 26. For data that is to be stretched across the two screens or for independent screens, for example two 1600×1200 resolution monitors, the data for each display device (20, 28) is stored in an adjacent manner in the local frame buffer 26. The data can be retrieved as a single image having an effective resolution of 3200×1200.

A frame buffer bus connects the local frame buffer 26 to a graphics controller 24. The graphics controller 24 can be a standard graphics controller found on graphics cards. It can be programmed to display only valid pixels (without blanking) in order to reduce bandwidth. The output of the graphics controller 24 is connected to a DVO bus which pumps out pixel data to be displayed. The graphics controller 24 can retrieve the two sets of data for each display (20, 28) in one retrieval step.

The data, which is essentially a serial input of pixels, is received by the sampling circuit 36 of FIG. 2. This circuit 36 produces two separate output streams of pixels for each respective output display (20, 28) and sends them back out on the DVO bus. Conversion circuitry (22, 32) on each DVO bus converts the DVO data to digital video interface (DVI) data and sends all data to the display devices (20, 28). Alternatively, different circuitry is used to convert the data to RGB data for analog displays (not shown).

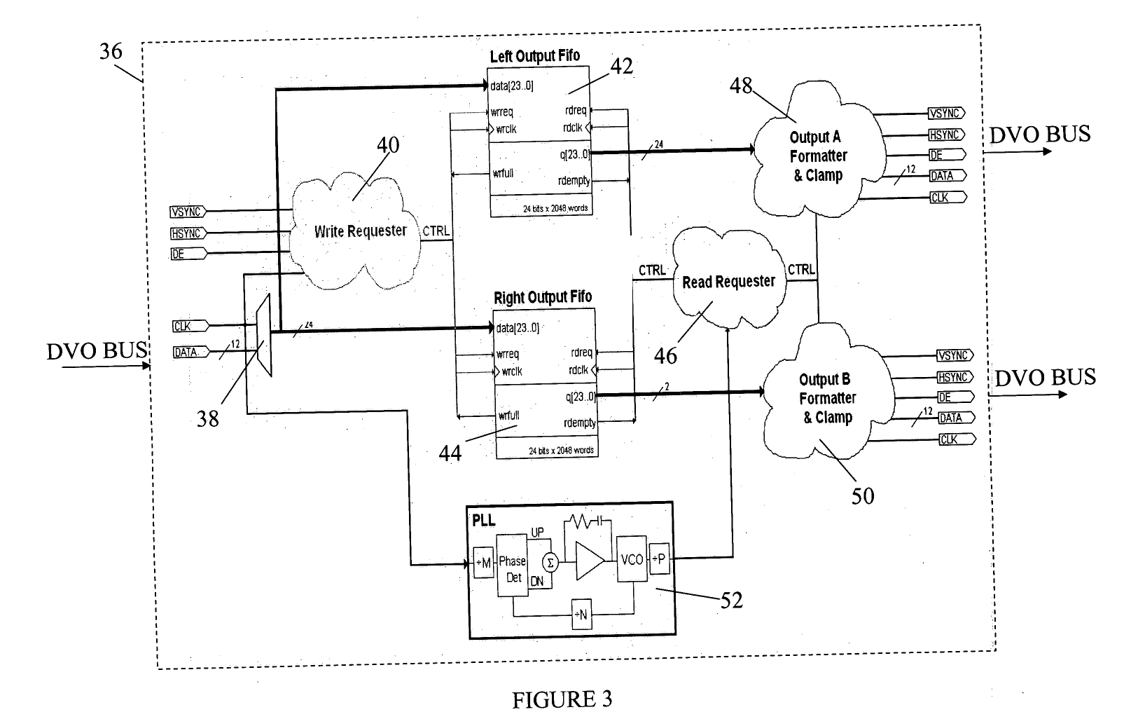

FIG. 3 is a detailed schematic of a preferred embodiment for the sampling circuit 36 of FIG. 2. The data is received serially by a demultiplexer 38, which selectively sends the pixels to either a left output First In First Out (FIFO) 42 or a right output FIFO 44. The left output FIFO 42 is a storage device for pixels that will be displayed on a first output device 20 while the right output FIFO 44 is a storage device for pixels that will be displayed on a second output device 28. A clock input determines the rate at which the demultiplexer 38 sends the data.

A memory control block 40, identified as a “write requester” in FIG. 3, is essentially a state machine that counts the pixels as they are received serially and output by the demultiplexer 38. It sends the command to the demultiplexer 38 to write to the left output FIFO 42 while the first half of the pixels are being received, and issues a command to write to the right output FIFO 44 after the first half of pixels have been received.

If the data is one big stretched image, half a line is sent to the left output FIFO 42, followed by the second half of the line sent to the right output FIFO 44, and back to the left output FIFO 42 for the next line, and so on. If the data is two independent images sent sequentially, the operation is the same. For the cloned displays, the circuit 36 can operate in either in the same way, or by sending half of all pixels to one storage device 42 first and the second half is then sent to the other storage device 44. It can split the data line by line if it was stored as a single image in the local frame buffer 26, or it can split the data by entire image. It all depends on how the data was stored in the local frame buffer and how it is interpreted by the system, i.e. as one image or two.

The write requester 40 also controls the left output FIFO 42 and right output FIFO 44. The formatting parameters which usually accompany the data, such as the horizontal synchronization signal (vsync), vertical synchronization signal (hsync), and data enable signal (DE), are all received by the write requester 40. These parameters are used for timing of the state machines in the write requester 40 and a read requester 46, described below.

Another memory control block 46, identified as “read requester” in FIG. 3, controls the outputs of the left output FIFO 42 and the right output FIFO 44. Once a given set of conditions are met, the read requester 46 issues the command to the FIFOs (42, 44) to begin outputting their respective data. The two FIFOs (42, 44) do not have to output data simultaneously, unless the system is displaying in a genlock mode, which means simultaneous display of images. If no genlock is required, the FIFOs (42, 44) can start outputting at different times, depending on what has been received by each. The size of each FIFO is adjustable. If a smaller FIFO is used, the data for the left FIFO 42 must be output sooner than the data for the right FIFO 44. The conditions for outputting the data are set as a function of the size of the FIFOs (42, 44). A specific FIFO size is required in the case the two screens are genlocked. Otherwise, smaller FIFOs are acceptable.

An example of a condition for output to the FIFOs (42, 44) is that the read requester 46 prompts the FIFO 42 to transmit as soon as one valid pixel is in the FIFO 42. Alternatively, the read requester 46 can be programmed to prompt the FIFO 42 to output as soon as half the FIFO 42 is full. Many alternatives exist for the set of conditions that can be used. These alternatives are known to a person skilled in the art.

Timing information needs to be programmed into the registers that are used in the circuit 36, such as in the read requester 46, the write requester 40, and the formatter and clamp modules (48, 50). These parameters can include H-(frequency, front porch, synch, back porch, blank, visible, total), V-(frequency, front porch, synch, back porch, blank, visible, total), compressed timing (i.e. fast clone mode, fast independent mode, Hi-Fi independent mode, etc), etc. Mathematical expressions are used to generate the value and address within the register that will result from the input of a select group of parameters. For example, if the values of V-Freq, H-Front Porch, H-Synch, H-Back Porch, H-Visible, V-Back Porch, V-Synch, and V-Visible are input into a table, mathematical formulas will produce the values for the registers in the modules of the circuit 36, and their corresponding addresses.

Some of these parameters are used by both the read requester 46 and the formatter and clamp modules (48, 50). The selection of the parameters are resolution dependent. These parameters are used for an implementation of the circuit 36 in an FPGA. It should be understood that they are not necessary for an implementation in ASIC.

The data for each display device (20, 28) is output to a formatter & clamp module (48, 50). Twenty four bits are received at each formatter (48, 50) and are reduced to 12 bit Double Data Rate (DDR) to increase performance by doubling the effective rate. Other formatting includes regenerating vsync, hsynch, and DE parameters to the data that correspond to the display device on which the image will be displayed. This is done by a series of pointers with programmable offsets.

A standard DVO clock 52, as is known in the art, is provided to control the write requester 40 and read requester 46. The write requester 40 is running at a higher frequency than the read requester 46. Additionally, the data input into the sampling circuit 36 is received at a higher frequency than the frequency at which it is output onto the DVO bus, in the case where the two monitors are one stretched image or independent images.

While FIG. 2 shows the conversion circuitry (22, 32) to be outside of the sampling circuit 36, it can be included within. The sampling circuit 36 can be implemented in an Application Specific Integrated Circuit (ASIC) or a Field Programmable Gate Array (FPGA), or in any other way known in the field by a person skilled in the art.

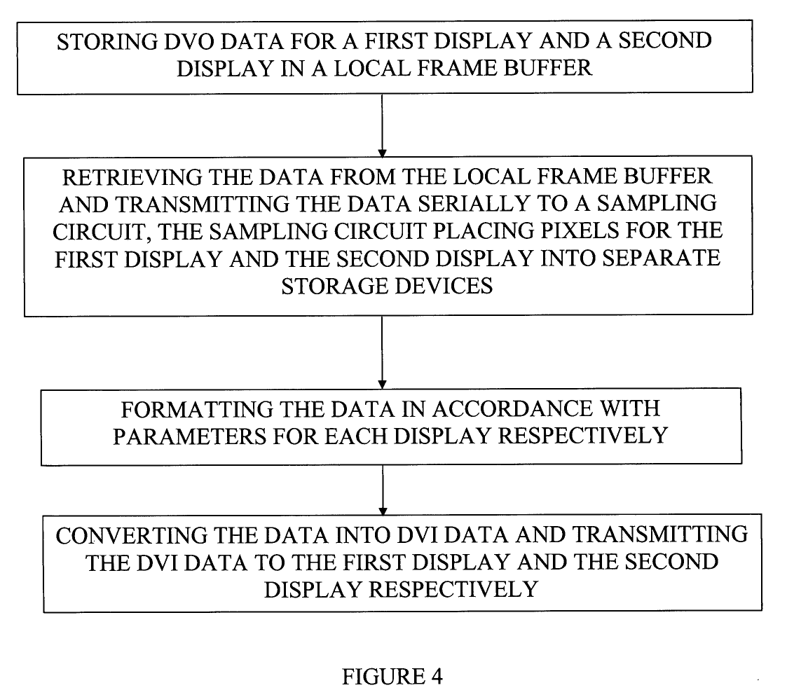

FIG. 4 is a flow chart illustrating the method of the preferred embodiment of the invention. The data is first stored in the local frame buffer 26. Each image is a matrix of pixels making up the image. The data can be stored as one large image or two smaller images. The data is then retrieved from the local frame buffer 26 by a graphics controller 24 and transmitted serially to a sampling circuit 36.

The sampling circuit 36 is so-called because it samples the pixels input to it and then performs a series of operations with them. The circuit 36 places pixels for a first display device 20 in a first storing device 42 and pixels for a second display 28 device in a second storing device 44. The pixels must then be reformatted to correspond to the monitors on which they will be displayed. Various offsets are added and a data enable signal is associated with the data. Before being displayed, the DVO data is converted into DVI data or RGB to be displayed on the digital or analog displays, respectively. The converted data is then sent to the appropriate display and a single DVO has produced dual display.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

The embodiment of the invention described above is intended to be exemplary only. The scope of the invention is therefore intended to be limited solely by the scope of the appended claims.

I claim:

1. A method for transforming a single digital video output into two digital video outputs, the method comprising:
storing digital video output data for a first display and a second display in a local frame buffer, said data comprising a plurality of pixels corresponding to a given resolution;
retrieving said data from said local frame buffer and transmitting said data serially to a sampling circuit, said sampling circuit placing pixels for said first display and said second display into separate storage devices;
formatting said data for said first display and said second display in accordance with parameters for each display respectively; and
transmitting formatted data to a first digital video output line and a second digital video output line.

2. A method as claimed in claim 1, wherein said storing digital video output data comprises positioning data for said second display directly adjacent to data for said first display in said local frame buffer.

3. A method as claimed in claim 2, wherein said retrieving said data comprises retrieving one image as big as said first display and said second display combined together.

4. A method as claimed in claim 1, wherein said placing pixels for said first display and said second display into separate storage devices comprises sending a first half of said pixels to a first storage device and sending a second half of said pixels to a second storage device, wherein said sending is controlled by a counter.

5. A method as claimed in claim 1, wherein said storing digital video output data comprises storing one image as big as said first display and said second display combined together in order to stretch said image across said first display and said second display.

6. A method as claimed in claim 5, wherein said retrieving said data comprises retrieving said one image in one step.

7. A method as claimed in claim 1, wherein said storing digital video output data comprises storing a single set of data to be displayed on both said first display and said second display, and said sampling circuit duplicates said data to place pixels for said first display and said second display into said separate storage devices.

8. A method as claimed in claim 1, wherein said transmitting said digital data to said first digital video output and said second digital video output comprises transmitting said data such that said first display and said second display begin displaying images simultaneously.

9. A method as claimed in claim 1, wherein said formatting comprises regenerating synchronization signals for said data.

10. A method as claimed in claim 1, wherein said sampling circuit is provided in an Application Specific Integrated Circuit.

11. A system for transforming a single digital video output into two digital video outputs, the system comprising:
a local frame buffer for storing digital video output data for a first display and a second display, said data comprising a plurality of pixels corresponding to a given resolution;
a graphics controller to retrieve said data from said local frame buffer and output said data serially; and
a sampling circuit adapted to receive said data serially, wherein said sampling circuit places pixels for said first display and said second display into separate storage devices and formats said data for said first display and said second display in accordance with parameters for each display respectively, and outputs said pixels for said first display on a first digital video output line and said pixels for said second display on a second digital video output line.

12. A system as claimed in claim 11, further comprising conversion circuitry to convert said digital video data into digital video interface data for display on digital devices.

13. A system as claimed in claim 11, wherein said graphics controller retrieves a single image from said local frame buffer.

14. A system as claimed in claim 13, wherein said single image is as big as said first display and said second display combined together.

15. A system as claimed in claim 13, wherein said sampling circuit duplicates said single image to transmit said single image to both said first display and said second display.

16. A system as claimed in 11, wherein said sampling circuit comprises a demultiplexer to send a first half of said pixels to a first storage device and a second half of said pixels to a second storage device, and said demultiplexer is controlled by a counter.
